(19) United States
(12) Patent Application Publication
(10) Pub. No.: US 2004/0054759 A1
(43) Pub. Date: Mar. 18, 2004

(54) Method for transferring files between service appliances and a remote management server

(76) Inventor: Rodolphe Grunenwald, Joinville-le-Pont (FR)

Correspondence Address: ROSENTHAL & OSHA L.L.P., 1221 MCKINNEY AVENUE, SUITE 2800, HOUSTON, TX, 77010, US

(21) Appl. No.: 10/416,657

(22) PCT Filed: Oct. 30, 2001
(86) PCT No.: PCT/IB01/02038

(30) Foreign Application Priority Data
Nov. 14, 2000 (FR) 00/14814

(51) Int. Cl. G06F 15/16; G06F 15/177

(52) U.S. Cl. 709/219; 709/221; 379/457

(57) ABSTRACT

The invention concerns a method for transferring computer files between a remote server (5) and a network of service appliances (10) such as public telephones, said files being used by said service appliances (10) for operating, the server (5) communicating with the service appliances (10) via a telecommunication network (2). The invention is characterised in that said files are first stored in the server (5), then transferred into a separate FTP server (4) from which they are downloaded by said service appliances (10), said service appliances having previously received instruction from said server (5) to proceed with the downloading of said files in said FTP server (4).

This invention concerns a method for transferring files between service appliances and a remote management server. This invention concerns in particular a method for transferring files between a management server and the telephones in a public telephony network.

A public telephony network consists of public telephones distributed over a given area. The public telephones are connected to a communication network, composed for example of the public switched telephone network (PSTN) that they communicate with via a modem.

A public telephony network generally includes one (or more) central computer or management server, often called Payphone Management System (PMS), enabling the network operator to supervise the various telephones in its network. The purpose of this PMS server, which is connected by modem to the switched telephone network, is to exchange with the fleet of telephones information concerning the operation of the telephony system.

In particular, the PMS server handles the downloading of the updates required for the programs controlling the public telephone circuits, updates correcting any errors detected in the programs already installed or perhaps adding new services for the users. Presently, this downloading of files is time consuming and therefore costly since global. A public telephone which downloads files must be switched out of service and cannot be used by the users throughout an operation which may last several hours considering the present size of the programs and data to be loaded.

Moreover, each new downloading campaign involves lengthy and complicated programming of the PMS server taking into account the type and size of the files to be transferred.

The objective of this invention is therefore to remove these disadvantages by simplifying and rationalising the transfer of data between a remote management server and service appliances such as public telephones.

The method according to the invention concerns the transfer of computer files between a remote management server and a network of service appliances, such as public telephones, the files being used by these service appliances for their own operation and the management server communicating with the service appliances via a telecommunication network.

According to the invention, the file transfer method is characterised in that the files are first stored in the management server then transferred into a separate FTP (File Transfer Protocol) server from which they are downloaded by the service appliances, these service appliances first having received the order from the management server to download (in the direction service appliances to FTP or FTP to service appliances) these files via the FTP server.

According to another characteristic of the method subject of this invention, the files are dimensioned so as to process only one functionality or a limited number of functionalities. The files therefore become modular.

According to another characteristic of the method subject of this invention, all operations carried out respectively by the management server and the service appliances are carried out using at least one command script comprising a series of instructions executable by the management server.

According to another characteristic of the method subject of this invention, the files to be transferred are grouped, for example according to their type; software, parameter tables, price tables, with a separate script for each group.

According to another characteristic of the method subject of this invention, each script includes a list of files to be downloaded.

According to another characteristic of the method subject of this invention, each script includes the name of the directory where the files to be downloaded in the FTP server will be stored as well as the access parameters (Internet address, identifier, password).

According to another characteristic of the method subject of this invention, each service appliance which will receive files first receives the order to connect to the management server at a given date and time. Connection of this device to the management server triggers the execution of one or more scripts, which consists of transferring the files from the management server to the FTP server, to a place predefined by the script, if not already carried out, and of transferring the list of files concerned to the service appliance which then downloads (removal or deposit) these files directly from/to the FTP server.

According to another characteristic of the method subject of this invention, to perform the transfer the management server only manages a copy of the files, the corresponding script(s) and a predefined list of the pay phones concerned.

According to another characteristic of the method subject of this invention, each file is identified by a name respecting a predetermined syntax.

According to another characteristic of the method subject of this invention, the file transfers between the management server, the FTP server and the service appliances are carried out via the Internet using the TCP/IP communication protocol.

The objectives, features and advantages of this invention will be clearer on reading the description which follows of a mode of realisation of the invention, given as a non-limiting example, and referring to the attached drawings in which:

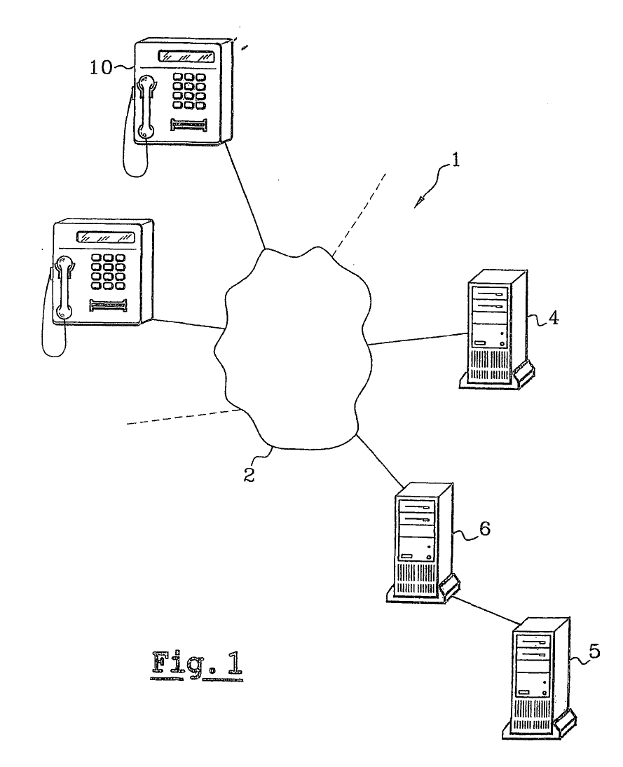

FIG. 1 is a diagrammatic view of a public telephony network used to implement the method according to the invention;

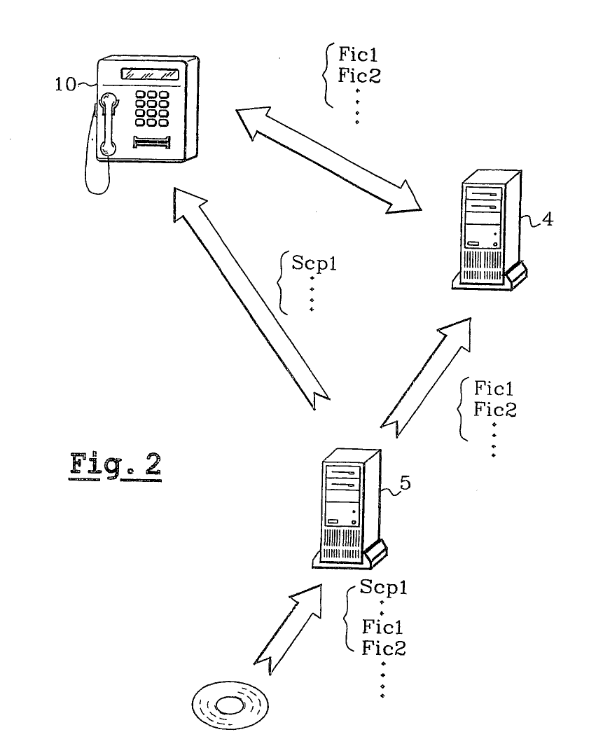

FIG. 2 illustrates a file transfer method according to the invention.

Only the elements of the public telephony network and of its environment required to understand the invention have been shown.

FIG. 1 shows a public telephony network 1. This network includes a fleet of public telephones 10 (a given fleet may include from a few dozen telephones to several thousands, or even tens of thousands, depending on the territorial coverage of the network).

The telephones 10 are intended for use by the general public and are therefore installed in public areas such as streets, or semi-public areas such as shopping centres, airports, hotel halls, restaurants, shops, etc.

These telephones 10 allow users to make telephone calls, using a suitable telephone network referenced 2. This telephone network 2 is PSTN (Public Switched Telephone Network) type or ISDN (Integrated Services Digital Network) type. This network 2 may also consist of a mobile radiotelephony network, of any type: GSM, CDMA, TDMA, AMPS, D-AMPS, or the Internet or more generally any communication network which can transmit data (X25, Ethernet, etc.) or by any combination of such networks.

These public telephones 10 may also be adapted to access information servers or Web and Internet service servers, as well as information or service servers hosted on private networks. Such accesses allow the operator operating the network 1 to offer users a wide range of services including, as non-limiting examples, reading their electronic mails and consulting local information (lists of doctors on duty in the public telephone area, etc.).

Obviously, the invention is not limited to public telephones offering this type of access to the Internet and to private servers.

In addition, these public telephones 10 are adapted to communicate with a server 5 known as the PMS (Payphone Management System) dedicated to operating and managing the public telephony network 1.

The purpose of the PMS 5 is to exchange with the fleet of public telephones 10 information concerning their operation and more generally the operation of the public telephony system. In particular, the PMS server 5 manages the public telephone initialisation sessions and generates statistical data using information received from the public telephones 10 (alarms, operation counters, etc.).

The public telephones 10 and the PMS 5 are equipped with suitable supervision and data reception/transmission means, these means which are known will not be described in further detail. These supervision and reception/transmission means are responsible for organising the information exchanges between the public telephones 10 and the PMS 5 or an FTP server 4, whose role will be detailed below, and in particular for controlling the transfers of data or software between the public telephones 10 and the FTP server 4.

Amongst other functions, the PMS 5 transfers to the public telephones 10 the files necessary for their operation, such as price tables, configuration parameters (e.g. the dialing type, line characteristics, etc.), lists for stopping or monitoring the payment means used.

The public telephones 10 transmit information concerning their use, i.e. a daily report including data on the transactions made, the traffic, an alarm report used to indicate to the PMS 5 any incidents or attacks on their integrity, such as failure of the card reader or a handset ripped out, in order to schedule the intervention of a technician and a status file indicating the content of the telephone (e.g. the various program versions used by the microprocessor).

To simplify the data exchanges, a server 4 is used, specifically designed and adapted for file transfer 4, known as an FTP (File Transfer Protocol) server. Using commands received by the PMS 5, each public telephone 10, which includes a client FTP server entity, will connect to the FTP server 4 and upload or download the appropriate files.

In addition, the public telephones 10 can connect to a PROXY server 6, acting as communication interface between the public telephones 10 and the PMS 5. The functions of the PROXY 6 will be described in more detail below.

These public telephones 10 are, which is known, terminals designed specifically for use on public or semi-public site. They therefore include special features in terms of hardware and software components, energy consumption, ergonomy, use, etc. which are well known and which will not be detailed any further.

Each public telephone 10 therefore includes various special elements, inherent to a public telephone, especially regarding the ergonomy. There are in particular display and data entry units, such as a screen 11 and a keypad 12. Also, the public telephone 10 implements software used to exchange and represent information according to specific formats better adapted to its ergonomy, although operating according to the principles of hypermedia links.

In addition, in order to connect to the various servers and especially the PROXY 6, the PMS 5 or the FTP server 4, the telephones 10 are equipped with TCP/IP communication protocols in compliance with the IETF (Internet Engineering Task Force) technical recommendations.

The PROXY 6 combines various functions. A first function consists of routing the requests from public telephones 10, depending on the nature of these requests, to the corresponding servers. It consists of a rerouting function used to store and update the list of addresses of the servers which could be called by the telephones 10 in the PROXY 6 only, not in each of the telephone terminals 10, since they only need to know the address of the PROXY 6 alone. With this mechanism, the maintenance operations on the telephony network 1 are considerably simplified.

Consequently, to communicate with the PMS 5, a telephone simply sends a message to the PROXY 6, message whose content, for example “initialisation”, simply has to be interpreted by the PROXY 6 as a message intended for the PMS 5. The PROXY 6 then has to find in its memories the IP address of the PMS 5 and send it the message.

A second function consists, whenever necessary, of translating the data or instructions transmitted by the telephones 10 into the format of the destination servers. If connecting to the Internet and the Web therefore, the protocol used by the public telephones 10 must be translated into the appropriate protocol (http, RMI, pop3, etc.) and vice versa to transfer the information from the Web and the Internet to the telephones 10.

Another function of the PROXY 6 is to check the syntax of the requests transmitted by the telephones 10 before retransmission and so authorise authenticated accesses to the network further behind (security). Another function is to set up reliable and authenticated data exchange sessions which consists, for example, of reliably identifying the telephones 10 during a data exchange with the servers, or of encrypting the data in order to make the communication more secure if necessary.

Another function of the PROXY 6 is to control and regulate the data exchanges carried out via standard file transfers in compliance with Internet protocols.

Another function of the PROXY 6 is to route the requests from the public telephones to backup servers especially if a server is unavailable, thereby providing architecture redundancy. Consequently, if the PROXY 6 should be inaccessible, due in particular to maintenance operations, the daily reports from the corresponding public telephones 10 can then be routed to another management server which is available. This switching from one server to another is then completely transparent for the public telephones 10 which consequently do not have to manage the backup addresses themselves, but only the address of the PROXY 6. Redundancy of the PROXY 6 itself is also possible, avoiding communication interruptions in the event of failure.

In practice, the PROXY 6 may consist of a PC type computer operating under Windows NT (registered trademark), Linux, etc.

All requests for connection to a server reach the computer input port which is permanently monitored by the PROXY 6, and are then rerouted to a working port. The request is then analysed by a software application, for example in Java (registered trademark) language, to check and set up a session as understood according to the protocol. A standard interface (socket) is then opened and the request is transmitted to the destination server, and vice versa.

Obviously, the mode of realisation illustrated has only been given as an example and in no way limits all the solutions which can be implemented using this invention.

The PROXY 6, the PMS server 5 and the FTP server 4, could therefore, instead of being separate machines as shown on FIG. 1, be contained in a single PC type computer for example.

The memories of the microcontroller in the electronic circuits (hardware) of each telephone 10 therefore store all data and programs (software) required for correct operation of the telephone.

According to the mode of realisation described, this data and these programs are divided into three separate groups of objects: the software, the parameter tables and the price tables. Obviously, this list is not limiting and can be increased according to the functionalities of the telephones (advertising, media, etc.). Of course, this breakdown into three types of objects, designed to simplify the network management by the operator, especially the handling of the PMS 5, does not limit this invention in any way, which still applies even if the data and programs are not split into separate groups. Obviously, each separate group of objects consists of a certain number of files.

Each file is modular, i.e. it only deals with a given functionality or a limited number of functionalities.

The software is therefore broken down into several dozen software modules including, for example: a module to secure the telephone line, a coin management module (if the telephone accepts coins), a payment card management module, a handset management module, a screen management module, a module to manage the charge units received from the line, an energy management module, a modem management module, etc.

The parameter tables include the features of the telephone network to which the telephone 10 is connected, the access authorisations to some services, the various language fonts used for the telephone display: French, English, German, Spanish, as well as Arabic, Chinese, Russian, etc.

Since the files are modular, interventions are more accurate and faster, especially for the downloading operations. When a new software version is released, it is therefore easier to simply load this new version into the hundreds or possibly thousands of telephones concerned rather than downloading all the software including the software which has not changed.

Each file is given a name respecting a specific syntax. For example, each file can be given a name of the following type “aa-bbb-ccc-ddd.ee” where:

“aa” is a two-digit number designating the type of telephone considered;

“bbb” is a three-digit number designating the file version;

“ccc” is a three-digit number designating the file revision;

“ddd” is a three-digit number designating the file extension;

“cc” is a string of two alphanumeric characters designating the file as such.

FIG. 2 shows a diagram illustrating the method used to transfer files from the PMS server 5 to the telephones 10, whether parameter tables, price tables, software or any other type of object. These files prepared using specific tools are loaded in the PMS server 5 via for example a CD-ROM, a diskette, or any other medium which can be read by the PMS or via a suitable communication network, whether private or public such as the Internet or the Web.

The files to be loaded in the telephones are accompanied by at least one corresponding script. A script is a text file with a series of instruction lines that will be executed by the PMS. In particular, a script includes the tree structure or directory which will store the files, the list of these files and instructions such as interrupts or disconnections.

All the files to be transferred can be grouped on a single script, or several scripts can be used if necessary, grouping the files according to type, for example. In the latter case, we could have a “price tables” script, a “parameter tables” script and a “software” script for example.

We will consider the case of a specific script by object type. Each script is then identified by a name of type xxxx.yyy where:

“xxxx” is the script name and “.yyy” the type of files considered: for example “.cli” for software, “.tt” for price tables, “.tp” for parameter tables, etc.

A script contains for example code lines of type:

group1.dir=soft/v02r00e02/group1 (group 1: name of the destination directory of a first batch of files)

group1.file1=03-002-000-001.40 (file to be loaded)

group1.flle2=03-002-000-001.41 (file to be loaded)

group1.file3=03-002-000-001.42 (file to be loaded)

group1.file4=03-002-000-001.43 (file to be loaded)

qroup1.file5=03-002-000-001.70 (file to be loaded)

group1.file6=03-002-000-001.71 (file to be loaded)

group1.file7=03-002-000-001.4A (file to be loaded)

group1.file8=03-002-000-002.4B (file to be loaded)

; S-disconnect here

group2.dir=soft;/v02r00e02/group2 (group2: destination directory of a second batch of files)

group2.file1=03-002-000-001.74 (file to be loaded)

group2.file2=03-002-000-001.75 (file to be loaded)

group2.file3=03-002-000-001.76 (file to be loaded)

group2.file4=03-002-000-001.79 (file to be loaded)

group2.file5=03-002-000-001.7B (file to be loaded)

group2.file6=03-002-000-001.7E (file to be loaded)

qroup2.file7=03-002-000-001.7F (file to be loaded)

. . . ”

This script and any other scripts concerning other types of file are therefore copied in the PMS server 5 at the same time as the files listed. Once the scripts and the files are stored in the PMS 5, the process to download the files in the telephone is started, having first selected the telephones concerned. It is possible, in fact, that files will only have to be downloaded to some of the telephones managed by the PMS 5.

This download process includes three steps: download the files into the FTP server 4, program the various telephones concerned and load the files into the telephones from the FTP server 4. Several methods can be used to perform these three steps.

Either the steps of the download process are clearly separated: the files are first loaded by the PMS into the FTP server 4 as soon as the download process is started, the telephones 10 are then programmed by the PMS one after the other as they make a connection to retrieve the files in the FTP 4, lastly the telephones 10 transfer the files from the FTP 4 into their microprocessors.

Or the steps of the download process are linked and the files are loaded into the FTP server 4 at the same time as the processing of the first telephone on the list is being executed (start the current download session).

Whatever process is used, these steps are based on the scripts.

We will consider the solution in which the various steps are linked. Once the instruction is given to start downloading files to a predetermined batch of telephones, the PMS 5 waits until the telephones concerned react. Each telephone 10 in the network 1 connects regularly to the PMS server 5 to send an activity report (or less regularly for specific reports such as an error report). When the PMS 5 identifies in the calling telephone one of the telephones concerned by the file download operation which has been started, it replies, sending a specific command.

This command consists of requesting the telephone to call back the PMS server 5 at a given date and time to perform the download. As soon as the request has been received, the telephone triggers an internal alarm program which will trigger the connection to the PMS server 5 at the given date and time.

As soon as the first telephone 10 calls to carry out the download, the PMS 5, using a special program also called an interpreter will execute the script(s) (depending on the number and type of files to be downloaded).

For a given script, the PMS 5 scans the instruction lines one after the other and executes the instructions, addressing alternately the FTP server 4 and the telephone 10. For the FTP server 4, the directory which will be used to store the files in the FTP 4 must be created and the files copied one after the other into this directory. For the telephone 10, the directory in the FTP server 4 storing the files to be downloaded as well as their names must be indicated.

Depending on the size of the files to be downloaded, the script execution may be carried out in a single operation or in several operations. If it is executed in several operations, the script includes intermediate disconnection instructions. On reception of this command, the telephone 10 interrupts the current session and rings back at a new predetermined time.

At the end of current execution of the script, all files are loaded in the FTP server 4 in the associated directory and the telephone 10 knows exactly the names and location of the files to be downloaded. The telephone 10 can then connect to the FTP server 4 whose IP address, as well as possibly a password, it has received and download the files according to the script(s) received from the PMS server 5.

The telephone 10 stores the files in a buffer memory as they are copied from the FTP server 4. When the first script is finished the next one is taken (if there are several scripts) after first installing in working memory (flash) the file received (identification, decompression, write, integrity, etc.) and the above-mentioned process is repeated.

The communication stops when all scripts have been executed. However, it may stop immediately after the first script for installation in the telephone circuits. Throughout these operations, the telephone has been able to access the FTP server 4 and the PMS server 5 simultaneously by using the TCP/IP communication protocol. Once the last file of the last script has been copied, the telephone informs the PMS 5 which then commands it to hang up. Once the communication has stopped, the telephone installs the files it has copied.

Obviously, when a second telephone then all the others connect to the PMS 5 to download files, it is no longer necessary for the PMS server 5 to copy files to the FTP server 4, all that is required is to transfer instructions to the telephones, i.e. supply the list of files to be copied and their location.

The method described above to transfer the files between the PMS 5 and the telephones 10 via the FTP server 4 has only been given as an example and numerous variants are possible. When the first telephone on the list to which files are to be downloaded calls, a file can be transferred to the FTP server 4 then the telephone instructed to copy it, and so on, file by file.

File transfer using this method is extremely flexible since it can be carried out module by module or even functionality by functionality, thereby removing the restrictions of the prior art where the files were unique and global. This method can be used to standardise the file transfer by proposing a unique and general management mode for all objects to be transferred, irrespective of their type or number. This dynamic management mode, in which the telephones execute one or more scripts transmitted by the PMS 5 and describing the work therefore has no effect either on the telephones or on the PMS server 5 whereas, according to the prior art, a processing procedure had to be developed specifically for each transfer.

Obviously, the mode of realisation illustrated has only been given as an example and in no way limits all the solutions which can be implemented using this invention.

The public telephone network described above can therefore be replaced by any network of service appliances which needs to transmit information, especially to a management server, for example ticket machines, automatic dispensers or bank terminals.

To program a telephone therefore, the PMS 5 can execute not the original script but a copy made specifically for this telephone. It is therefore possible to act on the original script, for example by modifying the name of a file to be transferred, without disturbing the download operations in progress.

Consequently, since all the files to be transferred are stored in a clearly identified directory of the FTP server 4, it is possible to transfer to the telephones 10 only the name of this directory without the file names, the telephones then transferring all files in the directory.

The FTP 4 does therefore not necessarily have to be part of the same machine or even belong to the same network but could be located somewhere else (geographic distribution).

1/ The invention concerns a method for transferring computer files between a remote server (5) and a network of service appliances (10), such as public telephones, said files being used by said service appliances (10) for operating, the server (5) communicating with the service appliances (10) via a telecommunication network (2). The invention is characterised in that said files are first stored in the server (5), then transferred into a separate FTP server (4) from which they are downloaded by said service appliances (10), said service appliances having previously received instruction from said server (5) to proceed with the downloading of said files in said FTP server (4).

2/ Method according to claim 1, characterised in that said files are dimensioned so as to process only one functionality or a limited number of functionalities.

3/ Method according to claim 1 or 2, characterised in that all operations carried out respectively by the server (5) and the service appliances (10) are carried out using at least one command script comprising a series of instructions executable by said server (5).

4/ Method according to claim 3, characterised in that the files to be transferred are grouped, for example according to their type: software, parameter tables, file transfer price tables, and in that there is a separate script for each group.

5/ Method according to claim 3 or 4, characterised in that said script includes a list of files to be downloaded.

6/ Method according to any of claims 3 to 5, characterised in that said script includes the name of the directory where the files to be downloaded into the FTP server (4) will be stored.

7/ Method according to any of claims 3 to 6, characterised in that each service appliance (10) which will receive said files receives the order to connect to said server (5) at a given date and time, in that said connection of said device to said server (5) triggers the execution of said script and in that said execution of said script consists of transferring said files from the server (5) to said FTP server (4) if not already carried out, and of transferring the list of files concerned to the service appliance (10) which then downloads said files directly from the FTP server (4).

8/ Method according to any of claims 3 to 7, characterised in that the server (5) receives to perform the transfer only a copy of the files, the corresponding script(s) and the list of the pay phones concerned.

9/ Method according to any of claims 1 to 8, characterised in that each file is identified by a name respecting a predetermined syntax.

10/ Method according to any of claims 1 to 9, characterised in that the file transfers between said server (5), said FTP server (4) and said service appliances (10) are carried out via the Internet network (2) using the TCP/IP communication protocol.
